(19) United States
(12) Patent Application Publication
(10) Pub. No.: US 2014/0031195 A1
(43) Pub. Date: Jan. 30, 2014

(54) ANIONIC GOLD-HYDROXO COMPLEX SOLUTION AND PROCESS FOR PRODUCING MATERIAL LOADED WITH GOLD NANOPARTICLES

(71) Applicants: Hiroaki Sakurai, Ikeda-shi (JP); Takae Takeuchi, Ikeda-shi (JP); Kenji Koga, Tsukuba-shi (JP); Masato Kiuchi, Ikeda-shi (JP)

(72) Inventors: Hiroaki Sakurai, Ikeda-shi (JP); Takae Takeuchi, Ikeda-shi (JP); Kenji Koga, Tsukuba-shi (JP); Masato Kiuchi, Ikeda-shi (JP)

(73) Assignee: NATIONAL INSTITUTE OF ADVANCED INDUSTRIAL SCIENCE AND TECHNOLOGY, Tokyo (JP)

(21) Appl. No.: 14/112,675

(22) PCT Filed: Apr. 18, 2012
(86) PCT No.: PCT/JP2012/060494

§ 371 Date: Oct. 18, 2013

(30) Foreign Application Priority Data
Apr. 19, 2011 (JP) 2011-093132

(51) Int. Cl. B01J 23/52; B01J 31/06; B01J 23/66; B01J 29/12

(52) U.S. Cl. CPC B01J 23/52; B01J 29/126; B01J 31/06; B01J 23/66
USPC 502/159; 502/344; 502/184; 502/243; 502/304

(57) ABSTRACT

The method for producing a material loaded with gold nanoparticles, includes: impregnating a carrier with an anionic gold-hydroxo complex solution including a transparent solution that has a pH of not lower than 8, does not contain a halide anion, and contains a conjugate base of a weak acid not coordinated to gold and an anionic hydroxo complex of trivalent gold having a square planar molecular geometry whose at least one ligand is OH⁻ and not containing a halide anion as a ligand; removing water; heating; and washing with water. According to the method, in a method for preparing a gold nanoparticle catalyst using a liquid phase method, a gold compound not containing a halide such as chloride is used as a raw material, and the gold compound can be supported efficiently. Furthermore, a gold nanoparticle-loaded catalyst having high activity can be obtained through a simple preparation method.

### TECHNICAL FIELD

The present invention relates to a solution of anionic gold-hydroxo complex, a method for producing the same, and a method for producing a material loaded with gold nanoparticles using the solution of anionic gold-hydroxo complex.

### BACKGROUND ART

In recent years, gold nanoparticle catalysts, obtained by having nanoparticles of gold supported on the surface of a carrier such as an oxide or the like, have been studied regarding the application thereof to various fields. Representative examples of applicable fields include indoor air purification, such as the oxidative removal of carbon monoxide; atmospheric environment preservation, such as NOₓ reduction; fuel cell-related reactions, such as selective oxidation of carbon monoxide mixed in hydrogen; reactions for chemical processes, such as a reaction for synthesizing a propylene oxide from propylene; and the like. In these cases, although it is necessary to change the type of carrier depending on the type of applied reaction, it is possible to improve the catalyst performance in all of the cases by immobilizing gold on a carrier surface as a hemispherical nanoparticle having a size of not larger than 10 nm, preferably not larger than 5 nm. Therefore, the selection of a preparation method that allows the good performance of the catalyst to be exhibited is particularly important.

Catalysts that have long been used, such as platinum catalysts and palladium catalysts, are often prepared through a so-called impregnation method. This impregnation method involves: immersing a carrier in a solution obtained by dissolving a noble metal compound, such as chloroplatinic acid, in a solvent such as water; removing the solvent, using a method such as evaporation to dryness, to cause chloroplatinic acid to be dispersedly supported on the carrier surface; and causing calcination and reduction to obtain platinum fine-particles. When platinum is used, it is possible to support platinum nanoparticles having a particle size of not larger than 5 nm using this method. This method is widely used because a variety of catalysts can be easily prepared by the combination of a noble metal compound and a carrier, and mass-production of the catalysts is easy.

However, when gold is used, a catalyst showing high activity cannot be obtained through a conventional impregnation method. If preparation is conducted with chloroauric acid using an impregnation method similar to the impregnation method used for platinum catalysts, the particle size of the gold becomes as large as about 30 nm. It has been indicated that this is due to, upon thermal decomposition, chloride contained in the raw material chloroauric acid that causes the gold to aggregate and become large-size particles. Furthermore, even after a thermal decomposition process, residual chloride causes poisoning of active sites for many catalytic reactions, resulting in, together with the aggregation of gold, a double whammy that significantly reduces activity.

Therefore, gold had been regarded as an inert element to be used as a catalyst until techniques for preparing gold catalysts using a coprecipitation method and a deposition-precipitation method were established. With the coprecipitation method, which was the first method to succeed in utilizing gold for a highly active catalyst, although chloroauric acid is used as a raw material, since a base is added thereto for neutralization to precipitate gold hydroxide Au(OH)₃ that does not contain chloride together with a precursor of a carrier oxide. At this stage, the coprecipitate is washed to remove chloride, and then dried and calcinated to obtain a highly active gold catalyst. The operation of washing the coprecipitate is particularly important, and it has been reported that even a minute amount of residual chloride of about 300 ppm increased the particle size of gold at the time of calcination. Therefore, it is necessary to repeatedly perform the washing operation, using a large amount of water. However, since it is also necessary to form the carrier oxide as fine particles in order to obtain a highly active catalyst having a large surface area, a long period of time is often required for separating water from the precipitate, even with filtration methods, decantation methods, or centrifuge separation methods ordinarily used in the washing operation. Therefore, performing the washing repeatedly until chloride is not detected is an operation that requires a great deal of time and effort.

Furthermore, since gold remaining in the liquid phase is washed away by the washing operation, a reduced amount of gold ultimately supported (hereunder, the amount of gold supported is referred to as gold loading amount) on the surface compared to the gold loading amount estimated from the preparation condition is also a large problem. With a gold/titanium oxide catalyst, it is possible to prepare a catalyst having high CO oxidation activity when preparation is conducted using a deposition-precipitation method at around pH 7. On the other hand, even when preparation is conducted using gold, for example, in an amount corresponding to 3 wt %, the actual gold loading amount in a gold/titanium oxide after preparation is about 1.5 wt %, and only approximately 50% of the used gold is supported. In addition, with the deposition-precipitation method, since the carrier that can support gold is limited to oxides that are basic or amphoteric, acidic oxides such as silica-alumina and silica cannot support gold.

Furthermore, described in the following Patent Literature 1, Non-Patent Literature 1, etc., is a method of impregnating titanium oxide with chloroauric acid; further impregnating the titanium oxide with sodium carbonate to cause deposition of gold hydroxide in fine pores; washing; and drying at 120° C. to obtain a gold/titanium oxide having high activity. However, with this method, since chloride cannot be fully removed through washing, a large amount of chloride is detected when compared to a deposition-precipitation method, and the activity is reduced after calcination at about 400° C. is conducted.

On the other hand, a method is reported in which Au/TiO₂ is prepared using gold acetate as a gold compound that does not contain chloride, with the same preparation conditions as that for a conventional deposition-precipitation method (cf. Non-Patent Literature 2 described below). With this method, although the amount of gold lost through washing is reduced by the usage of gold acetate, and the gold loading amount is improved, the resulting catalytic activity is inferior compared to when chloroauric acid is used as a raw material.

As described above, since processes for preparing gold nanoparticles in liquid phase have various drawbacks, methods of preparing a gold nanoparticle catalyst through a gaseous phase method or a solid phase method have also been studied. A representative gaseous phase method is a gaseous phase grafting method of evaporating and supporting dimethyl gold acetylacetonato complex (CH₃)₂Au(acac) in a vacuum line. Furthermore, one type of solid phase method is a solid phase mixing method of mixing and grinding the gold complex with a carrier in a mortar to highly disperse and support a sublimated gold precursor on the surface. In these methods, chloride is not contained in the raw material of gold; and it is possible to use various carriers such as metal organic frameworks, polymers, activated carbon, and acidic oxides that cannot be used as a carrier in a hitherto-known liquid phase method. However, the gold complex used in that method as a precursor is expensive. Furthermore, the sublimable gold complex is harmful for the human body, and it is necessary to prevent inhalation thereof. It is also not easy to conduct mass production due to apparatus-related problems.

### CITATION LIST

### Patent Literature

PTL 1: US20070219090A1

### Non-Patent Literature

NPL 1: M. Bowker et al., Catalysis Today 122 (2007) 245-247
NPL 2: C. Cellier et al., Studies in Surface Science and Catalysis, 162, p. 545, January 2006

### SUMMARY OF INVENTION

### Technical Problem

The present invention is made in view of the above-described status of the prior art. A main object of the present invention is to provide a new method, among methods for preparing a gold nanoparticle catalyst using a liquid phase method, that enables manufacturing of a highly active catalyst in which gold nanoparticles are loaded, using as a raw material a gold compound that does not contain a halide such as chloride, and enables efficient supporting of the gold compound through a simple preparation method.

### Solution to Problem

The present inventors conducted intensive research in order to achieve the above-described object. As a result, they discovered that, by using as a raw material a trivalent gold compound not containing a halide, such as gold acetate and gold hydroxide; suspending or dispersing said trivalent gold compound in water; and causing a hydrolysis reaction of the gold compound to progress in the presence of a conjugate base of a weak acid in a solution having a pH not lower than 8, a transparent solution having the gold compound uniformly dissolved therein can be obtained. In addition, they discovered that, with a method of impregnating various carriers with this solution, conducting calcination, and washing with water, it becomes possible to efficiently support the raw material gold compound to obtain a highly active gold catalyst in which gold nanoparticles are highly dispersed and supported. The present inventors thereby accomplished the present invention.

Therefore, the present invention provides, as described below, an anionic gold-hydroxo complex solution, a method for producing the same, and a method for producing a material loaded with gold nanoparticles.

Item 1. An anionic gold-hydroxo complex solution comprising a transparent solution that does not contain a halide anion and has a pH of not lower than 8,

the transparent solution comprising an anionic hydroxo complex of trivalent gold, and a conjugate base of a weak acid not coordinated to gold,

the anionic hydroxo complex of trivalent gold having a square planar molecular geometry whose at least one ligand is OH⁻, and not containing a halide anion as a ligand.

Item 2. The anionic gold-hydroxo complex solution according to item 1, the solution being a solution for impregnation to be used for producing a material loaded with gold nanoparticles.
Item 3. The anionic gold-hydroxo complex solution according to item 1 or 2, wherein the conjugate base of the weak acid not coordinated to gold is at least one member selected from the group consisting of carboxylate anion, carbonate ion, bicarbonate ion, citrate ion, phosphate ion, borate ion, and tartrate ion.
Item 4. A method for producing the anionic gold-hydroxo complex solution according to any one of items 1 to 3,

the method comprising causing a hydrolysis reaction of a trivalent gold compound to progress in the presence of a conjugate base of a weak acid in a solution that has a pH of not lower than 8 obtained by suspending or dispersing the trivalent gold compound not containing a halide in water.

Item 5. The method for producing the anionic gold-hydroxo complex solution according to item 4, wherein the trivalent gold compound not containing a halide is at least one member selected from the group consisting of gold carboxylates, gold oxides, gold hydroxides, and complex oxides of gold and an alkali metal.
Item 6. A method for producing a material loaded with gold nanoparticles,

the method comprising impregnating a carrier with the anionic gold-hydroxo complex solution according to any one of items 1 to 3, removing water therefrom, heating, and washing the carrier with water.

Item 7. The method for producing a material loaded with gold nanoparticles according to item 6, wherein the carrier is a metal oxide, a porous silicate, a metal organic framework, porous polymer beads, a carbon material, a ceramic honeycomb, or a metal honeycomb.

The method for producing gold nanoparticles of the present invention is described in detail below.

Raw Material Compound

In the present invention, a gold compound that contains trivalent gold and does not contain a halide is used as a raw material. Generally, chloroauric acid is often used as a raw material for producing a gold nanoparticle catalyst. However, when using chloroauric acid, it is necessary to remove residual chloride in order to obtain a catalyst with high activity and high dispersion of gold. Therefore, the process steps become complicated, and a problem arises wherein the utilization rate of gold becomes low.

Furthermore, it has been reported that an analysis value of 47 ppm is obtained for chloride in a gold reference catalyst Au/TiO₂ (Au 1.5 wt %) of the World Gold Council prepared by a deposition-precipitation method (M. Azar et al., Journal of Catalysis 239 (2006) 307-312). Therefore, it is difficult to greatly reduce chloride with an ordinary hitherto-known preparation method using chloroauric acid.

In the present invention, it is possible to obtain a catalyst having high activity and high dispersion of gold by solving problems due to the presence of a halide. This is done by using a trivalent gold compound not containing a halide as a raw material, preparing a solution of an anionic hydroxo complex of gold in which the gold compound is uniformly dissolved according to a later-described method, and manufacturing a gold nanoparticle catalyst using an impregnation method using the solution. Furthermore, even if the raw material gold compound contains 0.01 wt % of a halide as an impurity, and all of the halide remains in the gold catalyst after preparation, it is possible to largely reduce chloride compared to hitherto-known methods since the halide becomes at most 3 ppm or lower when the gold loading amount is 1.5 wt %.

In the present invention, the gold compounds shown in the following items (1) to (4), for example, can be suitably used as the trivalent gold compound not containing a halide.

(1) Gold carboxylates: Au(CH₃COO)₃, Au(C₂H₅COO)₃, and the like (basic salts such as Au(OH)(CH₃COO)₂, Au(OH)₂(CH₃COO), and the like may be included).
(2) Gold oxides: Au₂O₃.
(3) Gold hydroxides: Au(OH)₃.
(4) Complex oxides of gold and an alkali metal: NaAuO₂, KAuO₂, and the like.

Method for Producing Gold Nanoparticle Catalyst

(i) Preparation of Transparent Solution

In the present invention, first, the above-described trivalent gold compound not containing a halide is used as a raw material, and suspended or dispersed in water to obtain a solution having a pH of not lower than about 8, preferably a pH of not lower than about 10; and a hydrolysis reaction of the gold compound is made to progress in the presence of a conjugate base of a weak acid. The concentration of the gold compound in the solution is not particularly limited as long as a uniformly dispersed liquid is formed, and may ordinarily be within the range of about 0.001 to 10 wt %.

Specifically, the conjugate base of the weak acid to be contained in the solution refers to A⁻ represented in the following ionization formula of a weak acid HA.

HA [symbol] H⁺+A⁻ [Chem. 1]

The conjugate base of the weak acid used in the present invention is not particularly limited, as long as it is one defined above. Specific examples of the conjugate base of the weak acid include carboxylate anions such as acetate ion and propionate ion, carbonate ion, bicarbonate ion, citrate ion, phosphate ion, borate ion, tartrate ion, and the like.

To prepare the solution, in which the gold compound is suspended or dispersed in water, that contains a conjugate base of a weak acid and has a pH of not lower than 8, the trivalent gold compound may be added to an aqueous solution obtained by dissolving a salt of a weak acid with a strong base in water and adjusting the solution so that the pH of the solution becomes not lower than 8 when the gold compound is added thereto; or a salt of a weak acid with a strong base may be added to a solution obtained by suspending or dispersing a trivalent gold compound in water, thereby adjusting the pH of the solution to be not lower than 8. In these cases, the amount of a salt of a weak acid with a strong base may be an amount that causes the pH of the solution obtained by suspending or dispersing a gold compound in water to be not lower than 8. Furthermore, when using gold acetate or the like as the gold compound, since acetate ion, which is a conjugate base of a weak acid, is generated from the gold compound itself, the pH may be adjusted using a strong base such as NaOH or the like.

A uniform solution can be obtained when the pH of the solution is not lower than 8. When the pH value is lower than that, precipitate of gold hydroxide Au(OH)₃ is generated easily, and it becomes difficult to obtain a uniform solution.

As the salt of a weak acid with a strong base used for adjusting the pH to be not lower than 8, for example, a salt of a weak acid that generates the above-described conjugate base and that contains an alkali metal ion (K⁺, Na⁺, etc.), an alkaline earth metal ion (Ca²⁺, Ba²⁺, etc.), or the like as a cation component may be used. In particular, a salt of a weak acid containing an alkali metal ion as a cation component is preferably used.

The upper limit of the pH is not particularly limited; ordinarily, a pH of not higher than about 14 may be used.

With the solution prepared with the above-described methods, in which the gold compound is suspended or dispersed in water, that contains a conjugate base of a weak acid and has a pH of not lower than 8, a uniform aqueous solution of the gold compound cannot be obtained and a solution that contains a colloid of the gold compound is obtained at a stage where the solution is prepared, even when the gold compound is uniformly dispersed using an ultrasonic washing machine. However, hydrolysis of the gold compound progresses gradually, and a transparent uniform solution is obtained even at ordinary temperature when the gold compound is completely dissolved as an anionic gold-hydroxo complex after a long period of time. Ordinarily, in order to shorten the preparation time of the transparent solution, the solution is preferably heated to 80° C. or higher, and is particularly preferably boiled under reflux.

Compared to using gold acetate, a longer period of time is required to obtain a transparent solution in the same conditions when a gold hydroxide, a gold oxide, or the like is used as a gold compound. However, in any reaction condition, the intended transparent solution can be obtained when the reaction is allowed to progress until a colloid or undissolved portion of the raw material powder disappears. Even when an undissolved portion of the raw material powder is present, a transparent solution having the gold compound dissolved therein can be obtained if the supernatant of the solution is isolated.

The solution preparation method is, for example, a method wherein, when gold acetate is used as the gold compound and when sodium carbonate is used to adjust the pH, gold acetate is added to deionized water; the gold acetate is dispersed using a touch mixer, an ultrasonic washing machine, or the like to obtain a colloid; sodium carbonate aqueous solution is added to adjust the pH to be not lower than 8; and the solution is boiled under reflux to obtain a yellow transparent solution from a brown colloid solution within several minutes, obtaining a transparent colorless solution in approximately 10 minutes.

When the temperature of the solution is lowered to room temperature after the reaction, a uniform transparent solution is obtained. By using this solution, a catalyst can be prepared in accordance with the following steps. Although a minute amount of black precipitate may be isolated from the solution when the solution is left for about one day, it is also possible to use a solution obtained by filtering and removing the precipitate using a membrane filter or the like.

The transparent solution prepared with the above-described method is a hitherto-unknown solution that has uniformly dissolved therein an anionic hydroxo complex of gold not containing a halide such as chloride; and thereby does not contain a halide that is a cause of coarsening gold particles and that becomes a poisoning substance against a catalytic reaction. Therefore, with a method of impregnating a carrier with this solution through a later-described method, and heating the carrier, a highly active catalyst in which nanoparticles of gold are uniformly supported can be easily obtained.

This solution is a transparent solution that has a pH of not lower than 8, does not contain a halide anion, and contains a conjugate base of a weak acid not coordinated to gold and an anionic hydroxo complex of trivalent gold having a square planar molecular geometry whose at least one ligand is OH⁻ and not containing a halide anion as a ligand.

This solution comprises an anionic hydroxo complex of gold dissolved therein, wherein the anionic hydroxo complex does not contain a halide such as chloride. Therefore, the solution does not contain a halide that is a cause of coarsening gold particles and that becomes a poisoning substance against a catalytic reaction. Therefore, with a method of impregnating a carrier with this solution through a later-described method, and heating the carrier, a highly active catalyst in which nanoparticles of gold are uniformly loaded can be easily obtained. In addition, because a conjugate base of a weak acid is present therein, the solution has a buffering action, and its pH becomes stable. It is thought that this is useful in causing an interaction between the gold complex in the solution and a carrier at a constant condition, and generating uniform gold nanoparticles.

In the solution of the anionic hydroxo complex of gold, as an anionic hydroxo complex of trivalent gold, one that satisfies the following requirements of (1) to (4), for example, can be suitably used.

(1) A gold complex having a square planar molecular geometry represented by the following formula.

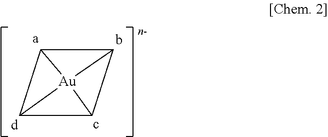

(2) An anionic complex having a negative charge as a whole due to coordination of anion ligands a, b, c, and d, and the gold being trivalent.

(3) At least one of the ligands a, b, c, and d being OH⁻.

(4) None of the ligands a, b, c, and d being a halide anion.

In the above-described anionic hydroxo complex of gold, the ligands of a, b, c, and d other than OH⁻ may be any ligand, as long as it is an anion ligand other than a halide anion. Examples thereof include acetate ion CH₃COO⁻, carbonate ion CO₃²⁻, and the like.

In the above-described formula, the value of “n” indicates the valence of negative charge determined by the type of anion ligand; and a value obtained by subtracting 3, which is the valence of gold, from the total valence of the anion ligands a, b, c, and d becomes the value of “n”.

The following compounds can be illustrated as such an anionic hydroxo complex of gold.

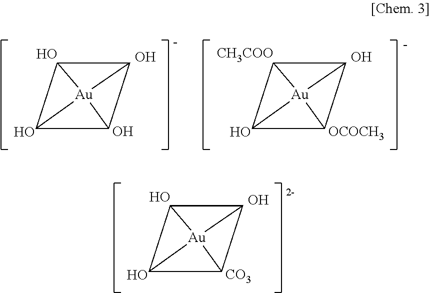

The anionic hydroxo complexes of gold in each formula described above may be respectively described as [Au(OH)₄]⁻, [Au(OH)₂(CH₃COO)₂]⁻, [Au(OH)₃(CO₃)]²⁻, etc.

These gold complexes do not have to be included in a solution for impregnation singly; they may be included as a mixture. For example, a solution containing 90% [Au(OH)₄]⁻ and 10% [Au(OH)₃(CH₃COO)]⁻ as an anionic hydroxo complex of gold may be used.

(ii) Impregnating Carrier

Next, the transparent solution containing the anionic gold-hydroxo complex prepared in accordance with the above-described method is used to impregnate a carrier.

The method for impregnating a carrier with the solution containing the anionic gold-hydroxo complex is not particularly limited. The method may be a method of immersing the carrier in the solution using an excessive amount of the solution with respect to the volume of the carrier; or an incipient-wetness method of impregnating the carrier by dropping the solution in an amount corresponding to the pore volume of the carrier. In these cases, it is necessary to adjust beforehand the concentration of the solution of anionic gold-hydroxo complex such that an intended loading amount of gold is obtained.

Next, the water is removed to immobilize the anionic gold-hydroxo complex on the carrier surface. The method for removing the water is not particularly limited; and any method can be used, including evaporation to dryness through heating on a hot plate, drying under reduced pressure using a rotary evaporator, a freeze-drying method, and the like.

In this case, the solution has a buffering action and its pH becomes stable since a conjugate base of a weak acid such as CO₃²⁻ and CH₃COO⁻ exists together with an alkali metal ion, an alkaline earth metal ion, or the like. It is thought that this is useful in causing an interaction between the gold complex in the solution and the carrier at a constant condition, and generating uniform gold nanoparticles.

On the other hand, if a conjugate base of a weak acid does not exist, it is thought that, after impregnating the carrier surface with the solution, the solution becomes concentrated in the process of removing the water and its pH gradually increases, resulting in a strong basic condition. During this process, it is thought that the adsorbed state of the gold complex to the carrier surface changes, causing generation of inhomogeneous gold nanoparticles and causing damage to the surface of the carrier oxide due to strong basicity.

The carrier that is used is not particularly limited, as long as it can be used commonly as a carrier of a noble metal catalyst. Examples thereof include: metal oxides described below; porous silicates such as zeolite, mesoporous silicate, and clay; metal-organic frameworks (MOF); porous polymer beads; carbon materials such as carbon nanotubes and activated carbon; ceramic honeycomb; metal honeycomb; and the like. The carrier used differs depending on the intended catalytic reaction and usage condition; for example, in an oxidation reaction, usage of a metal oxide is preferable from the standpoint of excellent adhesion with gold nanoparticles, ease of forming an active site at a contact interface, heat stability, etc.

Examples of such a metal oxide carrier that can be used include oxides containing a metal element such as beryllium, magnesium, aluminum, silicon, calcium, scandium, titanium, vanadium, chromium, manganese, iron, cobalt, nickel, copper, zinc, gallium, germanium, strontium, yttrium, zirconium, cadmium, indium, tin, barium, and lanthanoids. These metal oxides may be an oxide of a single metal including only a single type among the above-described metal elements, or may be a complex oxide including two or more types of the metal elements.

Among these metal oxides, in particular, a complex oxide or a metal oxide including one or more types of metal elements such as titanium, manganese, iron, cobalt, nickel, zinc, zirconium, lanthanum, and cerium is preferable. The complex oxide and the metal oxide of a single metal may be mixed to be used, if necessary. Depending on the production method, group 2 elements in the periodic table, such as beryllium, magnesium, calcium, strontium, and barium, may sometimes contain a hydroxide, a basic carbonate, or the like other than the corresponding oxide. In the present invention, the “oxide” for supporting gold in the form of nanoparticles may include a hydroxide, a basic carbonate, or the like.

In the material loaded with gold nanoparticles of the present invention, the gold content is not particularly limited, as long as it is possible to conduct the preparation such that gold is retained in a nanoparticle size. For example, by appropriately selecting the type of carrier and the method of preparation, a material loaded with gold nanoparticles having a gold content of about 0.1 to 60 wt %, based on the total amount of gold nanoparticles and the carrier, can be prepared.

The form of the material loaded with gold nanoparticles of the present invention can be appropriately selected depending on the purpose of use. For example, it can be used as a powder, or molded in the form of granules or pellets to be used. Furthermore, it is possible to immobilize the material loaded with gold nanoparticles on a support body to be used in the support body form. The shape of the support body is not particularly limited as long as it can immobilize the material loaded with gold nanoparticles on the surface thereof; and may be any shape such as tabular, block-like, fibrous, net-like, bead-like, or honeycomb-shaped. For example, when the support body is used in a honeycomb shape, it is possible to immobilize the material loaded with gold nanoparticles prepared as a powder to the surface of the honeycomb to be used; or immobilize the carrier on the surface of the honeycomb in advance and then use the supporting method of the present invention, causing the gold nanoparticles to be supported directly on the surface of the carrier. The material of the support body is not particularly limited as long as the support body is stable under the reaction condition and the condition for causing the gold nanoparticles to be supported; for example, various types of ceramics can be used.

The specific surface area of the material loaded with gold nanoparticles is, as a measurement obtained by BET method, preferably about 1 to 2000 m²/g, and more preferably about 5 to 1000 m²/g. In order to obtain such a material loaded with gold nanoparticles, a carrier having, for example, a specific surface area in the above-described range may be used as the carrier for supporting the gold nanoparticles.

(iii) Forming Gold Nanoparticles by Heating

Gold can be supported as metal nanoparticles by applying heat after the anionic gold-hydroxo complex is immobilized on the carrier surface using the above-described method. The atmosphere in which heat is applied is not particularly limited, and heat can be applied in various atmospheres such as an oxygen-containing atmosphere, a reducing-gas atmosphere, or an inert-gas atmosphere. Examples of the oxygen-containing atmosphere that can be used include an air atmosphere, and a mixed-gas atmosphere in which oxygen is diluted with nitrogen, helium, argon, or the like. Examples of the reducing gas that can be used include hydrogen gas, carbon monoxide gas, and the like diluted with nitrogen gas to about 1 to 10 vol %. Examples of the inert gas that can be used include nitrogen, helium, argon, and the like.

The heating temperature may be equal to or below the heat-stable temperature of the carrier, and may be ordinarily about 100 to 600° C. In order to obtain stable and fine gold particles, the heating temperature is preferably about 200 to 400° C. The heating time is not particularly limited, and the heating may be conducted for about 5 minutes or more after reaching a predetermined heating temperature in the above-described temperature range.

(iv) Removing Soluble Salt by Washing, and Drying

Next, the material loaded with gold nanoparticles obtained after the heating is washed with water. The carrier after the heating has a residual conjugate base of a weak acid such as acetate ion and carbonate ion in the form of an alkali metal salt, an alkaline earth metal salt, or the like. Although these salts do not cause strong poisoning as much as a halide anion, residual salts on the surface physically block active sites, and cause a reduction in activity. Therefore, residual salts are removed by washing the carrier with water after the heating.

The washing method is not particularly limited, and a washing method commonly performed can be appropriately used. Washing methods include, for example, a method of using a suction filter, and washing on a filter paper while pouring thereon deionized water; a decantation method of adding a material loaded with gold as a powder and deionized water in a beaker, and washing with water while replacing a supernatant solution; and a method of washing with water while separating precipitates and water using a centrifuge.

A material loaded with gold nanoparticles can be obtained by drying the carrier after the washing with water. As the drying temperature, a temperature lower than the temperature used for forming the gold nanoparticles by heating may be used, and the drying temperature may be ordinarily set at a temperature between room temperature and 150° C.

Material Loaded with Gold Nanoparticles

With the above-described method, a material in which gold nanoparticles are uniformly loaded can be obtained using a trivalent gold compound not containing a halide as a raw material.

Since the material loaded with gold nanoparticles obtained by the method of the present invention has gold nanoparticles uniformly supported on a carrier, and does not contain a halide that becomes a poisoning substance against a catalytic reaction, the material loaded with gold nanoparticles has high activity in various catalytic reactions. Therefore, the material loaded with gold nanoparticles can be effectively used as a catalyst in various fields in which gold nanoparticle catalysts have been used hitherto, including indoor air purification, such as the removal of carbon monoxide through oxidation; atmospheric environmental preservation, such as NOₓ reduction; fuel cell-related reactions, such as selective oxidation of carbon monoxide mixed in hydrogen; reactions for chemical processes, such as reaction for synthesizing a propylene oxide from propylene; and the like.

### Advantageous Effects of Invention

With the method for producing the material loaded with gold nanoparticles of the present invention, by using, as a raw material, a gold compound not containing a halide, a material in which gold nanoparticles are uniformly loaded can be obtained. With this method, a material loaded with gold nanoparticles having high activity and not containing a halide that becomes a poisoning substance against a catalytic reaction can be obtained with a simple processing method at a high yield for the gold compound.

### BRIEF DESCRIPTION OF DRAWINGS

FIG. 1 is a TEM picture of a gold-loaded material of Au/TiO₂ prepared using gold acetate in Example 2.

FIG. 2 is a TEM picture of a gold-loaded material of Au/Al₂O₃ prepared using gold acetate in Example 3.

FIG. 3 is a TEM picture of a gold-loaded material of Au/SiO₂ prepared using gold acetate in Example 4.

FIG. 4 is a TEM picture of a gold-loaded material of Au/TiO₂ prepared using chloroauric acid in Comparative Example 2.

FIG. 5 is a TEM picture of a gold-loaded material of Au/Al₂O₃ prepared using chloroauric acid in Comparative Example 3.

FIG. 6 is a TEM picture of a gold-loaded material of Au/SiO₂ prepared using chloroauric acid in Comparative Example 4.

FIG. 7 is a TEM picture of a gold-loaded material of Au/AC prepared using gold acetate in Example 8.

FIG. 8 is a TEM picture of a gold-loaded material of Au/PMA-DVB prepared using gold acetate in Example 9.

FIG. 9 is a TEM picture of a gold-loaded material of Au/HY prepared using gold acetate in Example 10.

FIG. 10 is a TEM picture of a gold-loaded material of Au/NaY prepared using gold acetate in Example 11.

FIG. 11 is a TEM picture of a gold-loaded material of Au/Saponite prepared using gold acetate in Example 12.

### DESCRIPTION OF EMBODIMENTS

In the following, the present invention will be described in further detail by means of Examples.

### Example 1

### Preparation and Activity Evaluation of Gold/Cerium Oxide (Au/CeO₂, Au 1.0 wt %)

20 mg of a brown powder of gold acetate (Au(CH₃COO)₃, manufactured by Alfa Aesar, 99.99% purity described in the certificate of analysis by the manufacturer) was added to 10 mL of an aqueous solution of sodium carbonate (0.1 mol/L), and dispersed using a touch mixer and an ultrasonic washing machine. Although undissolved precipitates were almost completely eliminated, since Tyndall phenomenon was observed when light from an LED light was irradiated on the side of the container, it was confirmed that the solution was not a true aqueous solution but a brown colloidal dispersion. The pH of this solution was 10.8.

When this dispersion was heated on a hot plate and a boiling state under reflux was maintained, the brown color almost completely disappeared after approximately 10 minutes. The heating was terminated at this stage, and the solution temperature was allowed to decrease to room temperature to obtain a transparent and colorless solution of anionic gold-hydroxo complex.

0.2 g of a yellow powder of cerium oxide (manufactured by Daiichi Kigenso Kagaku Kogyo Co., Ltd., grade A) was placed in a petri dish manufactured by PFA, and 2 mL of the anionic gold-hydroxo complex solution obtained by the above-described method was added thereto and mixed. Next, the PFA petri dish was heated to approximately 40° C. to allow the water to evaporate to dryness; and the dried product was transferred to a crucible and calcined for 30 minutes at 350° C. in a muffle furnace to obtain a black powder in which gold nanoparticles were loaded.

Next, in order to remove residual soluble salts, the powder was washed with deionized water, and dried at 100° C. to obtain a material in which ultrafine gold particles were supported on cerium oxide. The gold loading amount of the gold-loaded material thus obtained was 1.0 wt %. The obtained material was placed and stored in a glass tube bottle with a screw cap.

Catalytic activity of the material loaded with gold nanoparticles obtained by the above-described method was evaluated by conducting, with the method described below, an oxidation reaction of carbon monoxide at room temperature (23° C.) using a fixed-bed flow reactor.

First, 20 mg of the gold-loaded material powder and 0.5 g of quartz sand were mixed and put into a quartz reaction tube having an internal diameter of 6 mm. A mixed gas of CO (1%)+O₂ (20%)+He (balance gas) was passed through this reaction tube at 100 mL/min, and gas obtained at the outlet of the reaction tube was analyzed using a mass spectrometer and a photoacoustic spectrometer (PAS). CO conversion rate was calculated from concentration analysis values of CO₂ and CO after stabilization, and values expressed as the reaction rate are shown in Table 1 and Table 2.

### Example 2

### Preparation and Activity Evaluation of Gold/Titanium Oxide (Au/TiO₂, Au 1.0 wt %)

A solution of anionic gold-hydroxo complex was obtained in the same manner as Example 1, except that 9.7 mg of the powder of gold acetate was used. The pH of this solution was 10.9.

A gold-loaded material of gold/titanium oxide was obtained in the same manner as Example 1, except that 0.25 g of a powder of titanium oxide (Nippon Aerosil Co., Ltd., P25) was placed in a PFA petri dish, and 5 mL of the solution of anionic gold-hydroxo complex was added thereto. The gold loading amount of the gold-loaded material thus obtained was 1.0 wt %. Table 1 shows the results of a catalytic activity evaluation conducted for this gold-loaded material in the same manner as Example 1. FIG. 1 shows a TEM picture of the gold-loaded material thus prepared. From FIG. 1, it can be confirmed that ultrafine particles of gold not larger than about 10 nm were dispersedly loaded uniformly in the gold-loaded material thus obtained.

### Example 3

### Preparation and Activity Evaluation of Gold/Aluminum Oxide (Au/Al₂O₃, Au 1.0 wt %)

A solution of anionic gold-hydroxo complex was obtained in the same manner as Example 1, except that 19.2 mg of the powder of gold acetate and 20 mL of the aqueous solution of sodium carbonate (0.1 mol/L) was used. The pH of this solution was 10.7.

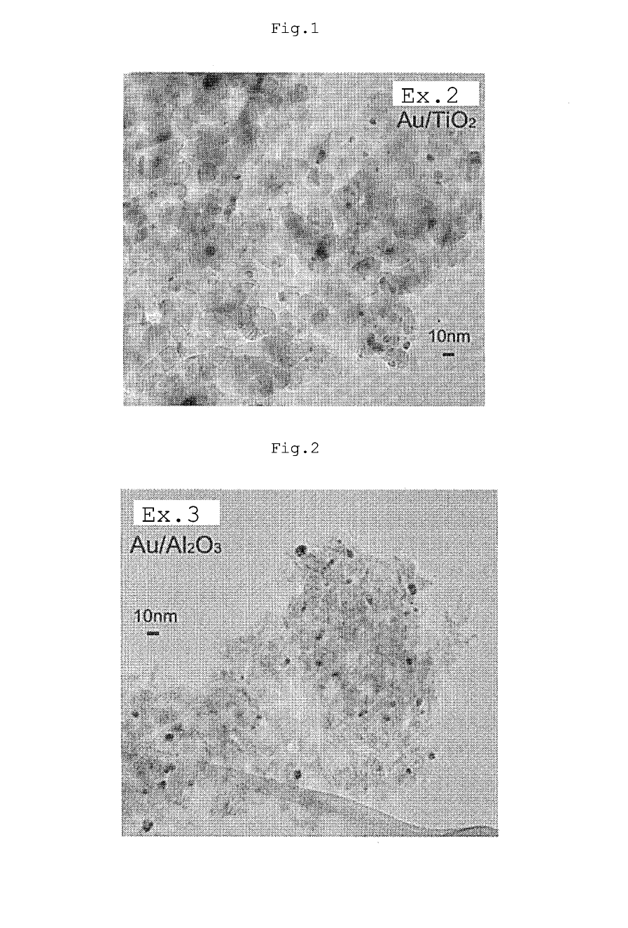

A gold-loaded material of gold/aluminum oxide was obtained in the same manner as Example 1, except that 0.4 g of aluminum oxide (Mizusawa Industrial Chemicals, Ltd., NEOBEADS GB) ground in a mortar and passed through a sieve to have its particle size adjusted to 125 to 500 μm in advance was placed in a PFA petri dish, and 8 mL of the solution of anionic gold-hydroxo complex prepared using the above-described method was added thereto. The gold loading amount of the gold-loaded material thus obtained was 1.0 wt %. Table 1 shows the results of a catalytic activity evaluation conducted for this gold-loaded material in the same manner as Example 1. FIG. 2 shows a TEM picture of the gold-loaded material thus prepared. From FIG. 2, it can be confirmed that ultrafine particles of gold not larger than about 10 nm were dispersedly loaded uniformly in the gold-loaded material thus obtained.

### Example 4

### Preparation and Activity Evaluation of Gold/Silica (Au/SiO₂, Au 3.0 wt %)

A solution of anionic gold-hydroxo complex was obtained in the same manner as Example 1, except that 39.2 mg of the powder of gold acetate and 10 mL of an aqueous solution of sodium carbonate (0.2 mol/L) was used. The pH of this solution was 10.4.

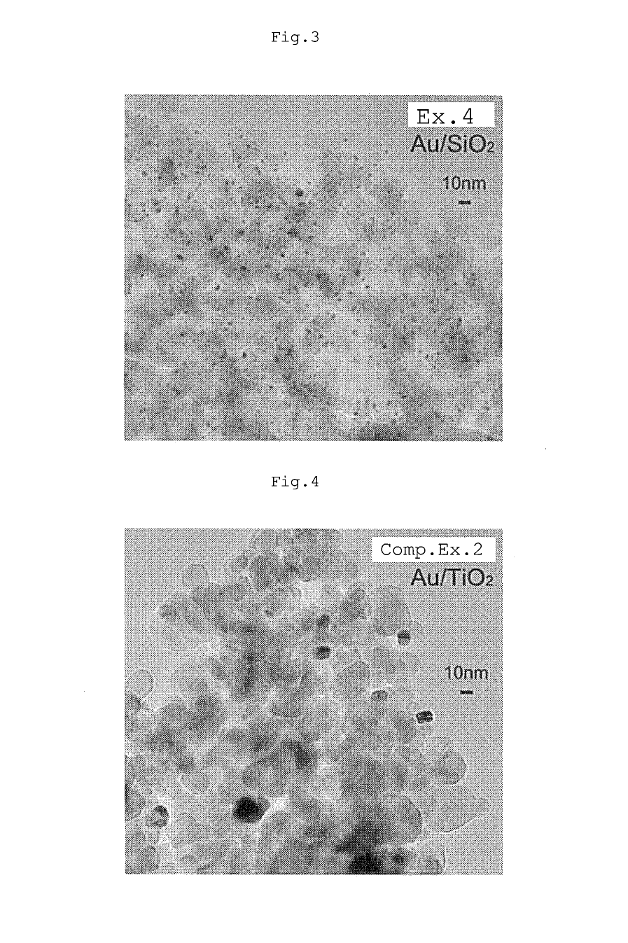

A gold-loaded material of gold/silica was obtained in the same manner as Example 1, except that 0.1 g of silica (Nippon Aerosil Co., Ltd., Aerosil 200) powder was placed in a PFA petri dish, and 1.5 mL of the solution of anionic gold-hydroxo complex obtained using the above-described method was added thereto. The gold loading amount of the gold-loaded material thus obtained was 3.0 wt %. Table 1 shows the results of a catalytic activity evaluation conducted for this gold-loaded material in the same manner as Example 1. FIG. 3 shows a TEM picture of the gold-loaded material thus prepared. From FIG. 3, it can be confirmed that ultrafine particles of gold not larger than about 5 nm were dispersedly loaded uniformly in the gold-loaded material thus obtained.

### Example 5

### Preparation (from a Sodium Carbonate Solution of Gold Hydroxide) and Activity Evaluation of Gold/Cerium Oxide

18.7 mg of a brown powder of gold hydroxide (Au(OH)₃, manufactured by Alfa Aesar) was ground in an agate mortar, and 10 mL of the aqueous solution of sodium carbonate (0.1 mol/L) was added thereto to obtain a suspension. The pH of this solution was 11.2. This suspension was heated on a hot plate, and a boiling state under reflux was maintained for 10 minutes to conduct the same process as in Example 1. Although some undissolved powder still remained, and the powder precipitated when the heating was terminated, the supernatant of the solution was transparent.

0.2 g of a yellow powder of cerium oxide (manufactured by Daiichi Kigenso Kagaku Kogyo Co., Ltd., grade A) was placed in a PFA petri dish, and 2 mL of the supernatant solution was added thereto; subsequently, the same process as in Example 1 was conducted. Since a black material loaded with gold was obtained as in Example 1, it can be determined that the supernatant solution after the boiling under reflux had gold dissolved as anionic gold-hydroxo complex, and that gold was ultimately supported on the surface of the cerium oxide in the form of nanoparticles.

Table 2 shows the results of a catalytic activity evaluation conducted for this gold-loaded material in the same manner as in Example 1. It should be noted that reaction rate per weight of gold was obtained under an assumed gold loading amount of 1.5 wt %, which is obtained when all of the used gold hydroxide is supported.

### Example 6

### Preparation (from a Potassium Carbonate Solution of Gold Acetate) and Activity Evaluation of Gold/Cerium Oxide

A solution of anionic gold-hydroxo complex was obtained in the same manner as in Example 1, except that 19.0 mg of the powder of gold acetate and 10 mL of an aqueous solution of potassium carbonate (0.1 mol/L) was used. The pH of this solution was 11.3.

A gold-loaded material of gold/cerium oxide was obtained in the same as in Example 1, except that 0.4 g of cerium oxide powder was placed in a PFA petri dish, and 4.0 mL of the solution of anionic gold-hydroxo complex prepared with the above-described method was added thereto. The gold loading amount of the gold-loaded material thus obtained was 1.0 wt %. Table 2 shows the results of a catalytic activity evaluation conducted for this gold-loaded material in the same manner as in Example 1.

### Example 7

### Preparation (from a Sodium Hydroxide Solution of Gold Acetate) and Activity Evaluation of Gold/Cerium Oxide

A gold-loaded material of gold/cerium oxide was obtained in the same manner as in Example 6, except that 18.4 mg of the powder of gold acetate and 10 mL of an aqueous solution of sodium hydroxide (0.1 mol/L) was used. The pH of this aqueous solution was 13.2.

The gold loading amount of the gold-loaded material thus obtained was 1.0 wt %. Table 2 shows the results of a catalytic activity evaluation conducted for this gold-loaded material in the same manner as in Example 1.

### Comparative Example 1

### Preparation and Activity Evaluation of Gold/Cerium Oxide (Au/CeO₂, Au 1.0 wt %)

A gold-loaded material of gold/cerium oxide was obtained in the same manner as in Example 1, except that 0.5 mL of a 0.1 mol/L aqueous solution of chloroauric acid (HAuCl₄) prepared in advance from chloroauric acid tetrahydrate (Kishida Chemical Co., Ltd.) and 9.5 mL of the aqueous solution of sodium carbonate (0.1 mol/L) were mixed to obtain a 10 mL solution. The pH of this solution was 10.5.

The gold loading amount of the gold-loaded material thus obtained was 1.0 wt %. Table 1 shows the results of a catalytic activity evaluation conducted for this gold-loaded material in the same manner as in Example 1.

### Comparative Example 2

### Preparation and Activity Evaluation of Gold/Titanium Oxide (Au/TiO₂, Au 1.0 wt %)

A gold-loaded material of gold/titanium oxide was obtained in the same manner as in Example 2, except that 0.25 mL of a 0.1 mol/L aqueous solution of chloroauric acid (HAuCl₄) and 9.75 mL of the aqueous solution of sodium carbonate (0.1 mol/L) were mixed to obtain a 10 mL solution. The pH of this solution was 10.7.

The gold loading amount of the gold-loaded material thus obtained was 1.0 wt %. Table 1 shows the results of a catalytic activity evaluation conducted for this gold-loaded material in the same manner as in Example 1. FIG. 4 shows a TEM picture of the gold-loaded material. From FIG. 4, it can be confirmed that, in the gold-loaded material thus obtained, gold fine particles had aggregated and were loaded in a state of particles exceeding 10 nm in size.

### Comparative Example 3

### Preparation and Activity Evaluation of Gold/Aluminum Oxide (Au/Al₂O₃, Au 1.0 wt %)

A gold-loaded material of gold/aluminum oxide was obtained in the same manner as in Example 3, except that 0.5 mL of a 0.1 mol/L aqueous solution of chloroauric acid (HAuCl₄) and 19.5 mL of the aqueous solution of sodium carbonate (0.1 mol/L) were mixed to obtain a 20 mL solution. The pH of this solution was 10.8.

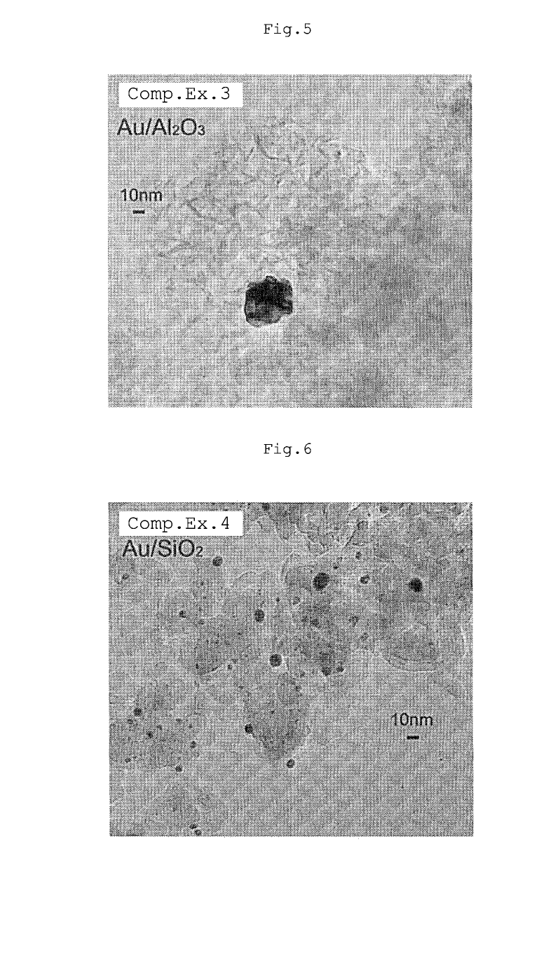

The gold loading amount of the gold-loaded material thus obtained was 1.0 wt %. Table 1 shows the results of a catalytic activity evaluation conducted for this gold-loaded material in the same manner as in Example 1. FIG. 5 shows a TEM picture of the gold-loaded material. From FIG. 5, it can be confirmed that, in the gold-loaded material thus obtained, gold fine particles had aggregated and were loaded in a state of particles exceeding 20 nm in size.

### Comparative Example 4

### Preparation and Activity Evaluation of Gold/Silica (Au/SiO₂, Au 2.9 wt %)

A gold-loaded material of gold/silica was obtained in the same manner as in Example 4, except that 1.0 mL of a 0.1 mol/L aqueous solution of chloroauric acid (HAuCl₄) and 9.0 mL of the aqueous solution of sodium carbonate (0.2 mol/L) were mixed to obtain a 10 mL solution. The pH of this solution was 10.1.

The gold loading amount of the gold-loaded material thus obtained was 2.9 wt %. Table 1 shows the results of a catalytic activity evaluation conducted for this gold-loaded material in the same manner as in Example 1. FIG. 6 shows a TEM picture of the gold-loaded material. From FIG. 6, it can be confirmed that, in the gold-loaded material thus obtained, particles exceeding 10 nm in size formed from aggregation of gold fine-particles existed.

### Comparative Example 5

### Preparation and Activity Evaluation of Gold/Silica (Au/SiO₂, Au 3.0 wt %)

A gold-loaded material of gold/silica was obtained in the same manner as in Example 4, except that the washing after the calcination at 350° C. in the preparation method of the gold-loaded material of gold/silica set forth in Example 4 was not conducted. The gold loading amount of the gold-loaded material thus obtained was 3.0 wt %. Table 1 shows the results of a catalytic activity evaluation conducted for this gold-loaded material in the same manner as in Example 1.

### Comparative Example 6

### Preparation and Activity Evaluation of Gold/Silica (Au/SiO₂, Au 2.9 wt %)

A gold-loaded material of gold/silica was obtained in the same manner as in Comparative Example 4, except that the washing after the calcination at 350° C. in the preparation method of the gold-loaded material of gold/silica set forth in Comparative Example 4 was not conducted. The gold loading amount of the gold-loaded material thus obtained was 2.9 wt %. Table 1 shows the results of a catalytic activity evaluation conducted for this gold-loaded material in the same manner as in Example 1.

### Comparative Example 7

### Preparation (from a Potassium Hydroxide Solution of Gold Hydroxide) and Activity Evaluation of Gold/Cerium Oxide

100 mg of a brown powder of gold hydroxide (Au(OH)₃, manufactured by Alfa Aesar) was ground in an agate mortar, and 7 mL of a potassium hydroxide aqueous solution (containing 24 mg of KOH) was added thereto and kept in a water bath at 82 to 85° C. A yellow transparent solution was obtained from a state of a thick, brown suspension after continuously applying heat for approximately 2 hours. The pH of this solution was 10.9.

A gold-loaded material of gold/cerium oxide was obtained in the same manner as in Example 1, except that 1.0 g of cerium oxide powder was placed in a PFA petri dish, and 0.97 mL of the gold solution prepared with the above-described method was added thereto. The gold loading amount of the gold-loaded material thus obtained was 1.1 wt %. Table 2 shows the results of a catalytic activity evaluation conducted for this gold-loaded material in the same manner as in Example 1.

### Comparative Example 8

### Preparation and Activity Evaluation of Gold/Cerium Oxide (from a Potassium Hydroxide Solution of Gold Hydroxide)

When 143 mg of a brown powder of gold hydroxide was ground in an agate mortar, and 10 mL of a potassium hydroxide aqueous solution (containing 34 mg of KOH) was added thereto and kept at a boiling condition under reflux, a brown suspension turned into a yellow transparent solution, and a transparent and colorless solution was obtained 2 hours later. The pH of this solution was 11.6.

A gold-loaded material of gold/cerium was obtained in the same manner as in Example 1, except that 1.0 g of cerium oxide powder was placed in a PFA petri dish, and 0.97 mL of the solution prepared by the above-described method was added thereto. The gold loading amount of the gold-loaded material thus obtained was 1.1 wt %. Table 2 shows the results of a catalytic activity evaluation conducted for this gold-loaded material in the same manner as in Example 1.

TABLE 1

| | | Au | | | | CO | Reaction |
|---|---|---|---|---|---|---|---|
| | | loading | | | Catalyst | conversion | rate |
| | | amount | Gold | Preparation | amount | rate | mol-CO |
| No. | Catalyst | wt % | compound | method | mg | % | s⁻¹ g-Au⁻¹ |
| Example 1 | Au/CeO₂ | 1.0 | Au(OCOCH₃)₃ | Impregnation, | 20.3 | 13.0 | 4.3 × 10⁻⁴ |
| | | | | washing | | | |
| Comparative | Au/CeO₂ | 1.0 | HAuCl₄ | Impregnation, | 20.5 | 0.7 | 2.4 × 10⁻⁵ |
| Example 1 | | | | washing | | | |
| Example 2 | Au/TiO₂ | 1.0 | Au(OCOCH₃)₃ | Impregnation, | 20.7 | 10.5 | 3.5 × 10⁻⁴ |
| | | | | washing | | | |
| Comparative | Au/TiO₂ | 1.0 | HAuCl₄ | Impregnation, | 19.6 | 5.7 | 2.1 × 10⁻⁴ |
| Example 2 | | | | washing | | | |
| Example 3 | Au/Al₂O₃ | 1.0 | Au(OCOCH₃)₃ | Impregnation, | 29.8 | 13.0 | 3.0 × 10⁻⁴ |
| | | | | washing | | | |
| Comparative | Au/Al₂O₃ | 1.0 | HAuCl₄ | Impregnation, | 30.5 | 0.5 | 1.2 × 10⁻⁵ |
| Example 3 | | | | washing | | | |
| Example 4 | Au/SiO₂ | 3.0 | Au(OCOCH₃)₃ | Impregnation, | 40.8 | 12.5 | 7.1 × 10⁻⁵ |
| | | | | washing | | | |
| Comparative | Au/SiO₂ | 2.9 | HAuCl₄ | Impregnation, | 40.8 | 1.6 | 9.5 × 10⁻⁶ |
| Example 4 | | | | washing | | | |
| Comparative | Au/SiO₂ | 3.0 | Au(OCOCH₃)₃ | Impregnation | 40.9 | 0.3 | 1.9 × 10⁻⁶ |
| Example 5 | | | | (no washing) | | | |
| Comparative | Au/SiO₂ | 2.9 | HAuCl₄ | Impregnation | 40.8 | 0.02 | 1.2 × 10⁻⁷ |
| Example 6 | | | | (no washing) | | | |

In Table 1 shown above, when the results between Example 1 and Comparative Example 1, Example 2 and Comparative Example 2, Example 3 and Comparative Example 3, and Example 4 and Comparative Example 4 are compared, it can be seen that the gold-loaded materials of Examples 1 to 4 prepared from gold acetate have higher activities than the gold-loaded materials of Comparative Examples 1 to 4 prepared from chloroauric acid.

In addition, since the gold-loaded materials obtained in Comparative Examples 5 and 6 were not washed, they resulted in low activities compared to the gold-loaded material obtained in Example 4.

TABLE 2

| | | Au | | | | | CO | |
|---|---|---|---|---|---|---|---|---|
| | | loading | | | | Catalyst | conversion | Reaction rate |
| | | amount | Gold | Dissolving | Dissolving | amount | rate | mol-CO |
| No. | Catalyst | wt % | compound | solution | condition | mg | % | s⁻¹g-Au⁻¹ |
| Example 1 | Au/CeO₂ | 1.0 | Au(OCOCH₃)₃ | Na₂CO₃ | Reflux- | 20.3 | 13.0 | 4.3 × 10⁻⁴ |
| | | | | | boiling | | | |
| Example 5 | Au/CeO₂ | 1.5 | Au(OH)₃ | Na₂CO₃ | Reflux- | 20.0 | 5.7 | 1.3 × 10⁻⁴ |
| | | | | | boiling | | | |
| Example 6 | Au/CeO₂ | 1.0 | Au(OCOCH₃)₃ | K₂CO₃ | reflux- | 22.4 | 1.6 | 5.0 × 10⁻⁵ |
| | | | | | boiling | | | |
| Example 7 | Au/CeO₂ | 1.0 | Au(OCOCH₃)₃ | NaOH | Reflux- | 22.3 | 7.7 | 2.4 × 10⁻⁴ |
| | | | | | boiling | | | |
| Comparative | Au/CeO₂ | 1.1 | Au(OH)₃ | KOH | Reflux- | 20.3 | 0.2 | 5.3 × 10⁻⁶ |
| Example 7 | | | | | boiling | | | |
| Comparative | Au/CeO₂ | 1.1 | Au(OH)₃ | KOH | 82-85° C. | 21.4 | 0.2 | 5.3 × 10⁻⁶ |
| Example 8 | | | | | | | | |

As is obvious from Table 2, high catalytic activities were observed with the gold-loaded materials of gold/cerium oxide of Examples 1 and 5 to 7 prepared using, as an impregnation solution, a solution containing a conjugate base (acetate ion or carbonate ion) of a weak acid in at least either the gold compound or the dissolving solution, compared to the gold-loaded materials of gold/cerium oxide of Comparative Examples 7 and 8 prepared using, as an impregnation solution, a solution that does not contain a conjugate base of a weak acid.

### Example 8

### Preparation and Activity Evaluation of Gold/Activated Carbon (Au/AC, Au 1.0 wt %)

A solution of anionic gold-hydroxo complex was obtained in the same manner as in Example 1, except that 20.0 mg of the powder of gold acetate and 20 mL of the aqueous solution of sodium carbonate (0.1 mol/L) was used. The pH of this solution was 10.7.

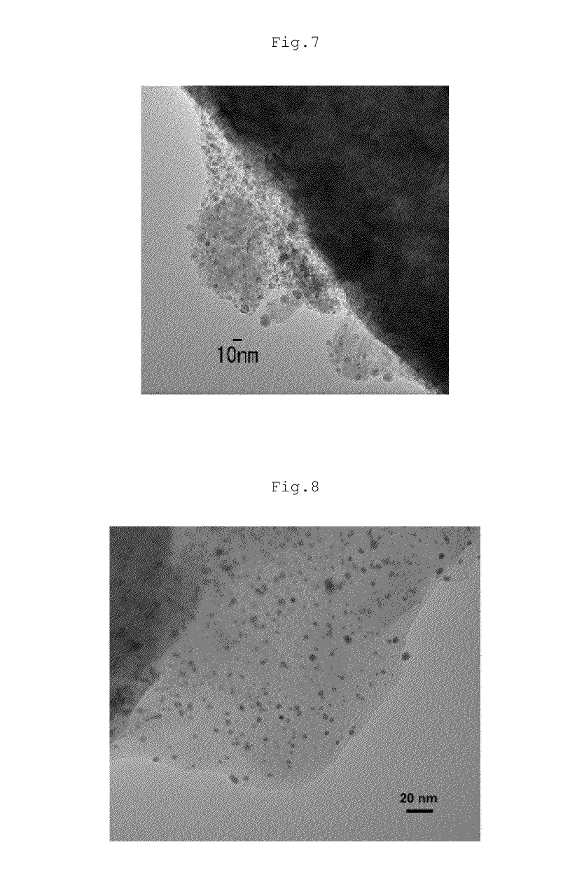

A gold-loaded material of gold/activated carbon was obtained in the same manner as in Example 1, except that a powder was obtained by grinding a granular activated carbon (AC, Japan Enviro Chemicals, Ltd., granular Shirasagi G2x) in a mortar and passing the ground product through a sieve with a particle size of 30 to 70 mesh; placing 0.4 g of the powder in a PFA petri dish; adding 8 mL of the solution of anionic gold-hydroxo complex thereto; and setting the heating temperature before washing at 200° C. The gold loading amount of the gold-loaded material thus obtained was 1.0 wt %. FIG. 7 shows a TEM picture of the gold-loaded material thus prepared. From FIG. 7, it can be confirmed that ultrafine particles of gold not larger than about 10 nm were dispersedly loaded uniformly in the gold-loaded material thus obtained.

Glucose oxidation reaction was conducted in water using the catalyst obtained with the above-described method. First, 4.4 g of glucose was dissolved in 83 mL of water (glucose concentration: 5 wt %), and the solution was heated to 60° C. Oxygen was bubbled therethrough at 60 mL/min while the solution was vigorously agitated at 1500 rpm, and a 1 mol/L sodium hydroxide aqueous solution was dropped therein using a burette to adjust the pH to 9.5. The pH was confirmed to be stable, and a reaction was started by adding, to the solution, 30 mg of a catalyst powder (equivalent to a mole ratio of 1:16000 for gold:glucose) that had been ground in a mortar to be a fine-powder state. A 1 mol/L sodium aqueous hydroxide solution was dropped therein so as to keep the pH of the aqueous solution in a range of 9.5±0.1. The produced amount of gluconic acid can be measured as a function of reaction time from the dropped amount of sodium hydroxide, since gluconic acid, which is an oxidation product of glucose, is neutralized by sodium hydroxide at a mole ratio of 1:1. Table 3 shows a glucose oxidation reaction rate obtained from the calculation.

### Example 9

### Preparation and Activity Evaluation of Gold/Resin-Beads Support (Au/PMA-DVB, Au 1.0 wt %)

A solution of anionic gold-hydroxo complex was obtained in the same manner as in Example 1, except that 19.0 mg of the powder of gold acetate and 20 mL of the aqueous solution of sodium carbonate (0.1 mol/L) was used. The pH of this solution was 10.7.

A gold-loaded material of gold/resin-beads was obtained in the same manner as in Example 1, except that 1.0 g of beads of polymethacryl-divinylbenzene resin (PMA-DVB, manufactured by ORGANO Corp., Amberlite FPC3500) was placed in a PFA petri dish, 20 mL of the solution of anionic gold-hydroxo complex was added thereto, and the heating temperatures before and after washing were 100° C. and 60° C., respectively. The gold loading amount of the gold-loaded material thus obtained was 1.0 wt %.

The gold-loaded material thus obtained with the above-described method was ground in a mortar, and a TEM observation was conducted on the powdered sample. FIG. 8 shows a picture thereof. From FIG. 8, it can be confirmed that ultrafine particles of gold not larger than about 10 nm were dispersedly loaded uniformly in the gold-loaded material thus obtained. Table 3 shows the results of grinding the prepared catalysts in a mortar and conducting glucose oxidation reaction in the same conditions as those in Example 8.

### Example 10

### Preparation and Activity Evaluation of Gold/H Type Y Zeolite (Au/HY, Au 1.0 wt %)

A solution of anionic gold-hydroxo complex was obtained in the manner as in Example 1, except that 19.0 mg of the powder of gold acetate and 20 mL of the aqueous solution of sodium carbonate (0.1 mol/L) was used. The pH of this solution was 10.7.

A gold-loaded material of gold/zeolite was obtained in the same manner as in Example 1, except that 1.0 g of a powder of proton type Y zeolite (HY, reference catalyst of the Catalysis

Society of Japan, JRC-Z-HY5.5) was placed in a PFA petri dish, 20 mL of the solution of anionic gold-hydroxo complex was added thereto, and the heating temperature after the washing was set at 60° C. The gold loading amount of the gold-loaded material thus obtained was 1.0 wt %.

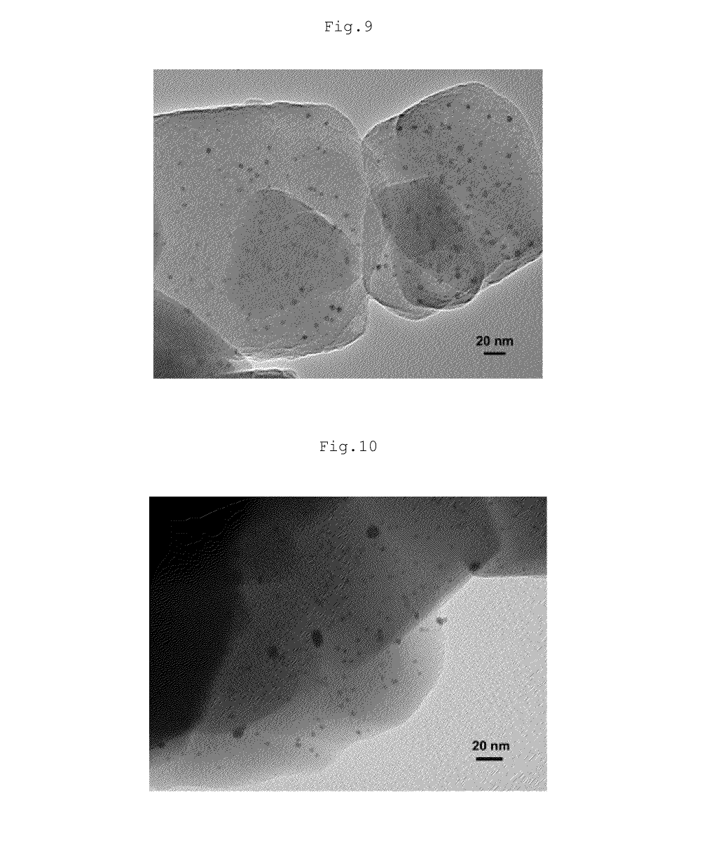

FIG. 9 shows a TEM picture of the gold-loaded material obtained with the above-described method. From FIG. 9, it can be confirmed that ultrafine particles of gold not larger than about 10 nm were dispersedly loaded uniformly in the gold-loaded material thus obtained. Table 3 shows the results of conducting glucose oxidation reaction using the prepared catalyst under the same conditions as those in Example 8.

### Example 11

### Preparation and Activity Evaluation of Gold/Na Type Y Zeolite (Au/NaY, Au 1.0 Wt %)

A solution of anionic gold-hydroxo complex was obtained in the same manner as in Example 1, except 19.0 mg of the powder of gold acetate and 20 mL of the aqueous solution of sodium carbonate (0.1 mol/L) was used. The pH of this solution was 10.7.

A gold-loaded material of gold/zeolite was obtained in the same manner as in Example 1, except that 1.0 g of sodium type Y zeolite (NaY, reference catalyst of the Catalysis Society of Japan, JRC-Z-Y5.5) was placed in a PFA petri dish, 20 mL of the solution of anionic gold-hydroxo complex was added thereto, and the heating temperature after the washing was set at 60° C. The gold loading amount of the gold-loaded material thus obtained was 1.0 wt %.

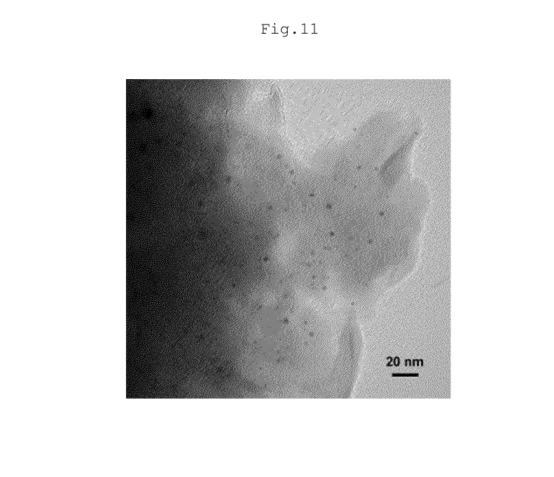

FIG. 10 shows a TEM picture of the gold-loaded material obtained with the above-described method. From FIG. 10, it can be confirmed that ultrafine particles of gold not larger than about 10 nm were dispersedly loaded in the gold-loaded material thus obtained. Depending on the observation location in TEM, it was observed that the gold particles not larger than 10 nm were partly loaded densely. Table 3 shows the results of conducting glucose oxidation reaction using the prepared catalyst under the same conditions as those in Example 8.

### Example 12

### Preparation and Activity Evaluation of Gold/Layered Clay (Au/Saponite, Au 1.0 wt %)

A solution of anionic gold-hydroxo complex was obtained in the same manner as in Example 1, except that 19.0 mg of the powder of gold acetate and 20 mL of the aqueous solution of sodium carbonate (0.1 mol/L) was used. The pH of this solution was 10.7.

A gold-loaded material of gold/layered clay was obtained in the same manner as in Example 1, except that 0.5 g of a powder of saponite (Saponite, Kunimine Industries Co., Ltd., Sumecton SA), which is one type of layered clay, was placed in a PFA petri dish, 10 mL of the solution of anionic gold-hydroxo complex was added thereto, and the heating temperature after the washing was set at 60° C. The gold loading amount of the gold-loaded material thus obtained was 1.0 wt %.

FIG. 11 shows a TEM picture of the gold-loaded material obtained with the above-described method. From FIG. 11, it can be confirmed that ultrafine particles of gold not larger than about 10 nm were dispersedly loaded in the gold-loaded material thus obtained. Glucose oxidation reaction was conducted using the prepared catalyst under the same conditions as those in Example 8, except that the catalyst amount was set to 8.3 mg. Table 3 shows the results.

TABLE 3

| | | Reaction rate |
|---|---|---|
| No. | Catalyst | mol-glucose s⁻¹ g-Au⁻¹ |
| Example 8 | Au/AC | 4.8 × 10⁻⁴ |
| Example 9 | Au/PMA-DVB | 1.6 × 10⁻² |
| Example 10 | Au/HY | 3.1 × 10⁻³ |
| Example 11 | Au/NaY | 8.7 × 10⁻³ |
| Example 12 | Au/Saponite | 1.5 × 10⁻¹ |

As is obvious from the results of Examples 8 to 12, it can be understood that, by using the solution of anionic gold-hydroxo complex of the present invention, gold not larger than about 10 nm can be supported, even with a porous body other than a simple oxide. In addition, catalytic activity for glucose oxidation was observed with all of the gold-loaded materials obtained in these Examples in which gold was supported on various carriers. In particular, when gold was supported on saponite, which is a layered clay (Example 12), a remarkably high activity was observed.

### Example 13

### Preparation and Activity Evaluation of Gold/Titanium Oxide Beads (Au/TiO₂, Au 0.1 wt %)

A solution of anionic gold-hydroxo complex was obtained in the same manner as in Example 1, except that 99 mg of the powder of gold acetate was added to 50 mL of the aqueous solution of sodium carbonate (0.1 mol/L). A 5-mL aliquot of this solution was obtained, 45 mL of water was added thereto to dilute the concentration of the aliquot to 1/10, and the obtained solution was stored in a glass tube bottle with a screw cap at room temperature for 4 months. The pH of this solution was 10.4.

A gold-loaded material of gold/titanium oxide beads was obtained in the same manner as in Example 1, except that 2.0 g of titanium oxide beads (Sakai Chemical Industry Co., Ltd., CS-300S-12) molded in a spherical shape having a diameter of 1 to 2 mm was placed in a PFA petri dish, and 20 mL of the solution of anionic gold-hydroxo complex after being diluted to 1/10 concentration (4 months had elapsed after preparation) was added thereto. The gold loading amount of the gold-loaded material thus obtained was 0.1 wt %. When catalytic activity evaluation was conducted using this gold-loaded material in the same manner as in Example 1, except for setting the catalyst amount to 200 mg, a CO conversion rate of 12.2% and an oxidation rate of 4.2×10⁻⁴ mol-CO s⁻¹g-Au⁻¹ were obtained. This oxidation rate exceeds the value obtained from the catalyst in which gold is supported on powdered titanium oxide in Example 2, and it can be understood that high catalytic activity can also be obtained even when gold is supported on a molded body other than powder, such as one in the form of beads.

In deposition-precipitation methods, which are the most widely implemented methods for causing gold to be supported on various carriers from an aqueous solution, gold is not supported as nanoparticles unless an oxide having an isoelectric point not lower than about pH=5 is used. Therefore, it was not possible for oxides that do not fit this condition, such as silica, zeolite, and clay; or non-oxide carriers, such as activated carbon and porous resin, to support gold nanoparticles. Furthermore, in solid phase mixing methods, in which dimethyl gold acetylacetonato complex is used, although gold nanoparticles can be supported on polymer powders, activated carbon, and oxides including silica, it was not possible to cause gold nanoparticle to be directly supported on molded carriers in forms such as beads form, since mixing is conducted in a solid phase wherein mechanical friction is applied with a mortar or the like.

On the other hand, as described above, by using the solution of anionic gold-hydroxo complex of the present invention, regardless of the type or form of the carrier, it is possible to cause gold nanoparticles to be directly supported from an aqueous solution.

1. An anionic gold-hydroxo complex solution comprising a transparent solution that does not contain a halide anion and has a pH of not lower than 8,
the transparent solution comprising an anionic hydroxo complex of trivalent gold, and a conjugate base of a weak acid not coordinated to gold,
the anionic hydroxo complex of trivalent gold having a square planar molecular geometry whose at least one ligand is OH⁻, and not containing a halide anion as a ligand.

2. The anionic gold-hydroxo complex solution according to claim 1, the solution being a solution for impregnation to be used for producing a material loaded with gold nanoparticles.

3. The anionic gold-hydroxo complex solution according to claim 1, wherein the conjugate base of the weak acid not coordinated to gold is at least one member selected from the group consisting of carboxylate anion, carbonate ion, bicarbonate ion, citrate ion, phosphate ion, borate ion, and tartrate ion.

4. A method for producing the anionic gold-hydroxo complex solution according to claim 1,
the method comprising causing a hydrolysis reaction of a trivalent gold compound to progress in the presence of a conjugate base of a weak acid in a solution that has a pH of not lower than 8 obtained by suspending or dispersing the trivalent gold compound not containing a halide in water.

5. The method for producing the anionic gold-hydroxo complex solution according to claim 4, wherein the trivalent gold compound not containing a halide is at least one member selected from the group consisting of gold carboxylates, gold oxides, gold hydroxides, and complex oxides of gold and an alkali metal.

6. A method for producing a material loaded with gold nanoparticles,
the method comprising impregnating a carrier with the anionic gold-hydroxo complex solution according to claim 1, removing water therefrom, heating, and washing the carrier with water.

7. The method for producing a material loaded with gold nanoparticles according to claim 6, wherein the carrier is a metal oxide, a porous silicate, a metal organic framework, porous polymer beads, a carbon material, a ceramic honeycomb, or a metal honeycomb.
